(19) United States
(12) Patent Application Publication
(10) Pub. No.: US 2025/0283399 A1
(43) Pub. Date: Sep. 11, 2025

(54) HYDRAULIC FRACTURING WITH OPTIMIZED FRICTION REDUCER

(71) Applicant: Liberty Energy Services LLC, Denver, CO (US)

(72) Inventors: Joel Siegel, Denver, CO (US); Kyle George, Denver, CO (US); Jon Sochovka, Denver, CO (US); Lindsey Moore, Denver, CO (US)

(21) Appl. No.: 19/071,903

(22) Filed: Mar. 6, 2025

Related U.S. Application Data
(60) Provisional application No. 63/562,665, filed on Mar. 7, 2024.

(51) Int. Cl. E21B 43/267; C09K 8/60; C09K 8/66; C09K 8/80; E21B 47/10

(52) U.S. Cl. CPC E21B 43/267; C09K 8/602; C09K 8/66; C09K 8/80; E21B 47/10; C09K 2208/28

(57) ABSTRACT

A series of pumping runs are made to determine an optimal content of inverting surfactant that may be added to a fracturing fluid for purposes of maximizing the performance of friction reducer that is added to the fracturing fluid during a hydraulic fracturing operation.

### CROSS-REFERENCE TO RELATED APPLICATIONS

This application claims priority to U.S. Provisional Patent Application No. 63/562,665 filed Mar. 7, 2024, entitled “Hydraulic Fracturing With Optimized Friction Reducer,” the disclosure of which is hereby incorporated by reference in its entirety.

### BACKGROUND

### Field of the Invention

The presently disclosed instrumentalities pertain to the field of hydraulic fracturing of subsurface rock to stimulate production from wells, such as gas, oil and geothermal wells, and particularly the use of friction reducers to facilitate pumping operations.

### Description of the Related Art

Hydraulic fracturing is a well-known well stimulation technique in which pressurized liquid is utilized to fracture rock in a subterranean reservoir. In the usual case, this liquid is primarily water that contains sand or other proppants intended to hold open fractures which form during this process. The resulting “frac fluid” may sometimes benefit from the use of thickening agents, but these fluids are increasingly water-based. Originating in about the year 1947, use of fracturing technology has grown such that approximately 2.5 million hydraulic fracturing operations had been performed worldwide by 2012. The use of hydraulic fracturing is increasing. Massive hydraulic fracturing operations in shale reservoirs now routinely consume millions of pounds of sand. Hydraulic fracturing makes it possible to drill commercially viable oil and gas wells in formations that were previously understood to be commercially unviable. Other applications for hydraulic fracturing include injection wells, geothermal wells, and water wells.

U.S. Pat. No. 11,675,336 to Jaaskelainen et al., which is hereby incorporated by reference to the same extent as though fully replicated herein, provides one example of a fleet of hydraulic fracturing equipment together with a centralized system of electronic controls for hydration units, blenders, and pumping units to achieve a well treatment objective using water, chemicals, and proppant that are mixed to form a fracturing fluid.

A well that is drilled with hydraulic fracturing in mind, for example, a well for producing oil and/or gas from shale, is generally speaking drilled to a vertical depth and then steered on a gradual gradient at the kickoff point until the well is horizontal after which drilling continues for a horizontal distance. The vertical depth may, for example, range from 5000 to 16,000 feet or more, and the horizontal distance may be up to four miles or more. Tens of millions of pounds of sand may be pumped for use as proppant. Casing is cemented into place to protect the wellbore, and a perforating gun retained on cable is pumped down to a predetermined depth. The perforating gun contains shaped charges that are programmatically addressable for detonation. These charges are detonated over a specific interval that is then isolated by the use of a retrievable packer. The specific interval is sometimes referred to as a stage, and this interval is subjected to hydraulic fracturing before the next stage is treated by repeating these steps.

Friction reducers are used to facilitate pumping operations for hydraulic fracturing. In essence, friction reducers make water slicker. U.S. Pat. No. 4,022,731 to Schmitt, which is hereby incorporated by reference to the same extent as though fully replicated herein, describes acrylamide or acrylamido friction reducer concentrates formed as water-in-oil emulsions. The emulsions contain:
A. an aqueous phase ranging from about 70% to about 95%, by weight, based on the total weight of A and B which is comprised of
   1. a water-soluble acrylamide polymer containing from about 0.0% to about 35.0% of an acrylic acid or (methacrylamidopropyl)trimethylammonium chloride comonomer, wherein said acrylic acid is from about 50% to about 100% neutralized, and having a concentration of from about 27% to about 68%, by weight, based on the total weight of (A), and
   2. water, in an amount ranging from about 32% to about 73%, by weight, based on the total weight of (A),
B. a liquid hydrocarbon oil in an amount ranging from about 5% to about 30%, by weight, based on the total weight of A and B,
C. a water-in-oil emulsifying agent (surfactant) dispersed between said aqueous phase and said liquid hydrocarbon at a concentration ranging from about 0.1% to about 15.0%, by weight, based on the total weight of A, B and C, and
D. an inverting surfactant (breaker) mixture comprising
   1. sodium bis(2-ethylhexyl)sulfosuccinate and
   2. a sodium bis(C₁₁-C₁₅ alkyl)sulfosuccinate or an ethoxylated octyl or nonyl phenol.

Other inverting surfactants well known to those of ordinary skill in the art may be suitably used. Generally speaking, inverting surfactants are those having a hydrophilic-lipophilic balance favoring attraction to the water phase of the emulsion, whereas the emulsifying surfactants have a hydrophilic-lipophilic balance favoring attraction to the oil phase of the emulsion.

In addition to friction reducers, other fracturing fluid additives well known to those of ordinary skill in the art include biocides to prevent microorganism growth and reduce biofouling of the fractures; oxygen scavengers and other stabilizers to prevent corrosion of metal pipes; and acids that are used to remove drilling mud damage. In the case of slickwater frac fluid, these additives may be added in minor amounts to form, by way of example, a frac fluid that is from 98% to 99.5% water and sand.

Other friction reducers for use in hydraulic fracturing include, for example, the polyacrylamide materials described in U.S. Pat. No. 11,274,242 to Seymour-Ioya et al., the cellulosic materials of U.S. Pat. No. 11,401,458 to Li et al., and the ionic polyacrylamide materials of U.S. Pat. No. 9,701,883 to Kumar et al.

In concentrate form, for example as taught by U.S. Pat. No. 4,022,731, the acrylic or acrylamido polymer material resides in the water micelles with the emulsifying agent stabilizing the emulsion at the water-oil interface. The inverting surfactant mostly resides in the water phase. As the concentrate is added to the frac fluid, the emulsifying agent preserves the water micelles even as the water micelles are blended into a water-based fracturing fluid. Within the blended fracturing fluid, the inverting surfactant mixture works against the emulsifying agent to destabilize the water micelles at which point the acrylic or acrylamido polymer is released into the dominant water phase of the fracturing fluid to enhance the friction reducing functionality of the acrylic or acrylamido polymer. The release of the acrylic or acrylamido polymer in this manner is commonly referred to in the art as ‘inverting the emulsion’ even though this occurs with water micelles in a water based fracturing fluid.

It is problematic in the art to determine the amount of inverting surfactant that should be added to the fracturing fluid. Too much of the inverting surfactant material causes a premature release of the acrylic or acrylamido polymer, which is subsequently degraded into shorter chain polymers by chemo-physical action in the borehole. Too little of the inverting surfactant may prevent breakdown of the water micelles, which then fail to release their polymer load for optimum effect. In this regard, the nature and quality of hydraulic fracturing fluid source water significantly affects the activity of the inverting surfactant in the intended environment of use. Source water may be, for example, recycled from other fracturing operations, freshwater or agricultural runoff, produced saltwater, or a brine prepared to stabilize shale. Factors affecting the functionality of inverting surfactants include, for example, brine concentration, sulfate content, pH, and cations—especially divalent cations—when the inverting surfactant is an anionic surfactant.

While samples of the fracturing source water may be taken for laboratory analysis to inform the choice of inverting surfactant concentration, this is too often ineffective or impractical in the intended environment of use. Hydraulic fracturing locations are most often located in remote areas where advance logistical planning is needed to assure that suitable chemicals are on hand. Moreover, the nature and quality of water are most often unknown and the source of water may change during the course of a hydraulic fracturing operation.

### SUMMARY

The instrumentalities disclosed herein overcome the problems outlined above and advance the art by providing a method for enhancing the efficient use of a friction reducer by adjusting the amount of inverting surfactant that should be added to a fracturing fluid.

According to one embodiment, a method of optimizing friction reducer content, includes:
(a) mixing a fracturing fluid that includes water, proppant, a friction reducer, an emulsifying surfactant, and an inverting surfactant;
(b) each of the friction reducer, the emulsifying surfactant and the inverting surfactant being respectively provided at predetermined concentrations;
(c) pumping the fracturing fluid into a wellbore while controlling for a stable flowrate;
(d) monitoring a pressure of the fracturing fluid over a period of time while the step of pumping is underway;
(e) changing a selected one of the predetermined concentrations to a different concentration;
(f) repeating the foregoing steps (a) through (e) at the different concentration;
(g) repeating step (f) a plurality of times;
(h) using data obtained from step (d) in a programmatic algorithm to determine an optimized concentration of the friction reducer;
(i) mixing the optimized concentration of the friction reducer in one or more subsequent fracturing fluids; and
(j) introducing the one or more subsequent fracturing fluids into a geologic formation to stimulate production therefrom.

In one aspect, wherein the programmatic algorithm may provide optimization, at least in part, by determining an area under a pressure reduction curve.

In other aspects, the selected one of the predetermined concentrations is a concentration in a category selected from the inverting surfactant, emulsifying surfactant, and friction reducer. This category may be held the same for all instances of step (e).

### BRIEF DESCRIPTION OF THE DRAWINGS

There will now be shown and described by way of nonlimiting example one or more embodiments for practicing what is claimed.

FIG. 1 is a flowchart showing a method of optimizing the use of a friction reducer by adjusting the amount of inverting surfactant that is added to a fracturing fluid;

FIG. 2 shows an algorithmic process of using data obtained from the method shown in FIG. 1 to determine a total amount of friction loss attributable to any one predetermined concentration of friction reducer; and

FIG. 3 shows an algorithmic process of using calculation results from the algorithmic process of FIG. 2 to determine an optimized concentration of friction reducer.

### DETAILED DESCRIPTION

There will now be shown and described, by way of non-limiting examples, various instrumentalities for overcoming the problems discussed above.

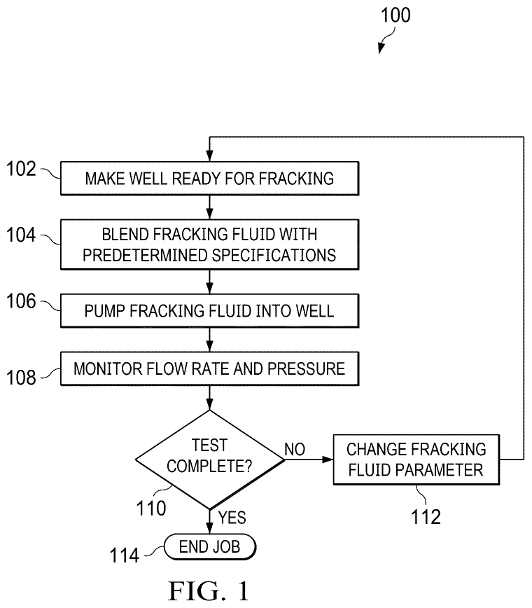

FIG. 1 shows a method 100 for enhancing the efficient use of a friction reducer by adjusting the amount of inverting surfactant that is added to a fracturing fluid. Step 102 entails making a well ready for hydraulic fracturing operations. At this stage, the well is drilled and casing or a liner is cemented into place. The stage of the well that is to be hydraulically fractured is isolated for pressure pumping operations. A fleet of hydraulic fracturing equipment, for example, as shown in U.S. Pat. No. 11,675,336 is rigged up and connected to the wellhead.

The hydraulic fracturing equipment is used to blend 104 a fracturing fluid having predetermined content. The predetermined content preferably includes water and a predetermined proppant concentration which may, for example, be suitably from 0.1 to 4 pounds per gallon, together with chemical additives as are well known to those of ordinary skill in the art and mixed in the normal course of treating a well to stimulate a well through the use of hydraulic fracturing. These chemical additives preferably include a predetermined concentration of friction reducer which may be mixed using a water-in-oil emulsion concentrate in the form of the friction reducer as described in U.S. Pat. No. 4,022,731, or another commercially available emulsified concentrate utilizing inverting surfactants as described above. While also blending, the hydraulic fracturing equipment is used to pump 106 the frac fluid into the well according to the design of a hydraulic fracturing operation for that particular stage. The predetermined specifications of the fracturing fluid are kept substantially constant while pumping, preferably varying not more than a threshold amount such as 1%, 2%, 4%, 5% or 10% by weight or by volume of the fracturing fluid. While pumping, the flow rate is also maintained at a substantially constant level and the pressure is monitored 108. The pressure is preferably a wellhead pressure, but may also be a bottomhole pressure, for example, as determined by U.S. Pat. No. 11,754,747 to Weijers et al., which is incorporated by reference to the same extent as though fully replicated herein.

The specification for the fracturing fluid is changed 112 for the purpose of performing a ladder test. This means that one of the predetermined specifications is varied and all other properties of the fracturing fluid are maintained at a substantially constant level. Although any fluid specification may be varied for this purpose, the amount of inverting surfactant may be changed to another concentration. The content of material used as a friction reducer in a fracturing fluid ranges suitably, for example, from 0.25 to 1 pounds per thousand pounds of frac fluid. To perform the ladder test on such a fluid, the concentration of inverting surfactant may be suitably changed, for example, among various selected values in the range from 0.1 to 0.4 percent of the amount of friction reducer.

If all pumping runs are not complete 110 then the well is made ready 102 for pumping a subsequent run, which in step 104 is blended to the new predetermined specification from step 112. As used herein, a “pumping run” may be an interval of pumping time used to perform a hydraulic fracturing operation on any isolated depth range or ‘stage’ in a well, or an interval of pumping successive runs into a single stage of a well such that each pumping run stimulates a single stage at successive times. Pumping operations cease 114 when all pumping runs are complete. It will be appreciated that simultaneous operations may occur on multiple wells such that, in operations sometimes called a zipper-frac, one well is subjected to pressure pumping operations in step 106 while another well is made ready for fracking in what is step 102 for that other well.

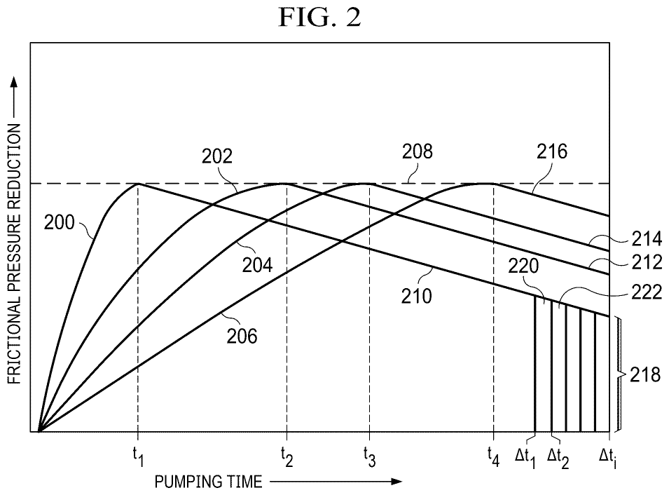

FIG. 2 shows a plurality of friction pressure reduction profiles that may be calculated using the monitored pressure data from step 108. Although the Y-axis can be wellhead pressure reduction in a horizontal section of a well it is possible to calculate frictional pressure reduction, P_{fpr}, due to the addition of a friction reducing material according to Equation (1):

$${P}_{fpr} = {P}_{max} - {P}_{red} \qquad ( 1 )$$

where Pₘₐₓ is a maximum total pumping pressure using a fracturing fluid with no friction reducing material added and P_{red} is the reduced pumping pressure with the friction reducing concentrate added.

It will be appreciated that the friction reducer material may be mixed using concentrates as described above or mixed in the hydration unit or blender using individual ingredients.

In FIG. 2, curves 200, 202, 204, 206 represent different pumping runs through the method 100 (see FIG. 1), in each run varying the concentration of inverting surfactant. A dashed line 208 shows the maximum amount of frictional pressure reduction that is possible for a certain type and concentration of friction reducer. In an ideal case, the line 208 is Virk's asymptote which is the maximum amount of frictional pressure loss that is obtainable from any type and concentration of friction reducer. Practically speaking, the Virk's asymptote is usually about 80% of P_{fpr}. What happens, however, is that the curves 200-206 rise to the value of line 208, at respective times t₁, t₂, t₃, t₄ and are thereafter subject to chemo-physical degradation resulting in declining sections 210, 212, 214, 216. Thus, for example, curve 200 would be the best case represented in FIG. 2 but-for the effect of chemo-physical degradation.

Finite difference mathematics may be used to calculate an area under each of the curves 200-206. This is shown by example in region 218 of FIG. 2. The area is estimated by a series of rectangles 220, 222 having a uniform width of Δt1, Δt2. The intercept may be calculated, for example, as a first forward difference. This may be done for the entire length of curve 200 or just a selected portion thereof.

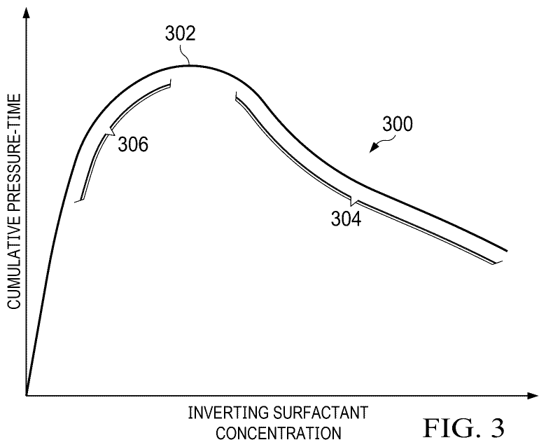

FIG. 3 shows that respectively calculating the area under the curves 200-206 and plotting this against friction reducer concentration yields a curve 300 having an optimal value 302 that separates a rising portion 306 from a falling portion 304.

Those of ordinary skill in the art will understand that the foregoing discussion teaches by way of example and not by limitation. Accordingly, what is shown and described may be subjected to insubstantial change without departing from the scope and spirit of invention. The inventors hereby state their intention to rely upon the Doctrine of Equivalents, if needed, in protecting their full rights in the invention.

We claim:

1. A method of optimizing friction reducer content, the method comprising steps of:
(a) mixing a fracturing fluid that includes water, proppant, a friction reducer, an emulsifying surfactant, and an inverting surfactant,
(b) each of the friction reducer, emulsifying surfactant and inverting surfactant being respectively provided at predetermined concentrations;
(c) pumping the fracturing fluid into a wellbore while controlling for a stable flowrate;
(d) monitoring a pressure of the fracturing fluid over a period of time while the step of pumping is underway;
(e) changing a selected one of the predetermined concentrations to a different concentration;
(f) repeating the foregoing steps (a) through (e) at the different concentration;
(g) repeating step (f) a plurality of times;
(h) using data obtained from step (d) in a programmatic algorithm to determine an optimized concentration of the friction reducer;
(i) mixing the optimized concentration of the friction reducer in one or more subsequent fracturing fluids; and
(j) introducing the one or more subsequent fracturing fluids into a geologic formation to stimulate production therefrom.

2. The method of claim 1, wherein the programmatic algorithm determines an area under a pressure reduction curve.

3. The method of claim 1, wherein the selected one of the predetermined concentrations is the concentration of the inverting surfactant.

4. The method of claim 1, wherein the selected one of the predetermined concentrations is the concentration of the emulsifying surfactant.

5. The method of claim 1, wherein the selected one of the predetermined concentrations is the concentration of the friction reducer.

6. The method of claim 1, wherein the selected one of the predetermined concentrations is a concentration in a category selected from the inverting surfactant, the emulsifying surfactant, and the friction reducer, the category being the same for all instances of step (e).
